(19) United States
(12) Patent Application Publication
(10) Pub. No.: US 2008/0128500 A1
(43) Pub. Date: Jun. 5, 2008

(54) Method And System For Determination Of Position

(76) Inventors: Tomas Ussing, Frederiksberg (DK); Martin Frohling Jensen, Naestved (DK)

Correspondence Address: KNOBBE MARTENS OLSON & BEAR LLP, 2040 MAIN STREET, FOURTEENTH FLOOR, IRVINE, CA, 92614, US

(21) Appl. No.: 11/666,308

(22) PCT Filed: Oct. 26, 2005
(86) PCT No.: PCT/DK05/00687

§ 371 Date: Dec. 14, 2007

(30) Foreign Application Priority Data
Oct. 26, 2004 (DK) PA 2004 1643

(51) Int. Cl. G06K 7/10

(52) U.S. Cl. 235/454

(57) ABSTRACT

The present invention relates to a method and device for determining the position of an inserted cartridge in an apparatus, where knowledge of position relative to interfacing components of the apparatus is of importance when connecting said components to the inserted cartridge. The invention involves an optical scanning device in said apparatus and optical beam path influencing structures on or in said cartridge. Furthermore methods for reading cartridge type, stock number, bulk data or similar types of information, are also disclosed.

### FIELD OF THE INVENTION

The present invention relates to a method and device for determining the exact position of an inserted cartridge in an apparatus, where knowledge of exact position relative to interfacing components of the apparatus is of importance when connecting said components to the inserted cartridge. Furthermore, methods for obtaining information about cartridge type, stock number and similar types of information is also disclosed.

### TECHNICAL BACKGROUND

A number of technical devices makes use of the insertion of a cartridge—either for supplying consumables to the device or for taking part in the functions of the device, or in fact to facilitate either simultaneously.

One of the major challenges of these devices is how to obtain a precise positioning of the cartridge relative to the device.

### SUMMARY OF THE INVENTION

Thus, an objective of the present invention is to provide cost effective systems, cartridges and methods of obtaining precise information about the position of a cartridge relative to a device or relative to at least a components of the device.

Another objective of the present invention is to provide systems and cartridges for and methods of obtaining precise information about the position of the cartridge relative to the device or relative to at least a component of the device without relying on high-precision assembly of the device of the system.

A further objective of the present invention is to provide systems and cartridges for and methods of reading a label of a cartridge.

Still a further objective of the present invention is to provide systems and cartridges for and methods of obtaining precise information about the position of the cartridge relative to the device or relative to at least a component of the device, and furthermore reading a label of the cartridge.

Yet a further objective of the present invention is to provide systems for and methods of producing products comprising cartridges.

An aspect of the present invention relates to a system comprising
(a) a cartridge comprising at least one beam diverting structure (BDS), and
(b) a device comprising
   (i) a cartridge site capable of receiving the cartridge,
   (ii) a laser scanning device (LSD) capable of emitting a beam of electromagnetic radiation, said LSD being able to move the beam relative to a cartridge associated with the cartridge site, and
   (iii) an optical detector (OD),
      the LSD and the OD being so positioned that when the cartridge is associated with the cartridge site and the beam of the LSD is moved to the at least one BDS, the signal from the OD is significantly modified (e.g. increased or decreased).

It is envisioned that the beam of the LSD may both be moved fully or partly to the at least one BDS.

Relating said significantly modified signal of the OD associated with said at least one BDS with a positioning control system of the LSD, will enable the LSD to access discrete positions on the cartridge, provided said discrete positions has a known relative positional relationship with said accessed BDS.

In the present context the terms “beam of electromagnetic radiation” and “beam” are used interchangeably.

In an embodiment of the present invention, the device furthermore comprises a first programmable device. In the present context a “programmable device” may e.g. be a programmable computer or a microcontroller system containing embedded program memory, or a programmable logic type of controller (e.g. PEEL, PAL, FPGA, GAL etc.).

In a preferred embodiment of the present invention, the programmable device is programmed to perform one or more steps of the methods described herein. E.g. the programmable device may control an automated movement of the device.

In another embodiment of the present invention, the means for moving the beam of the LSD may comprise a deflection device and/or a diffraction device that can deflect and/or diffract the beam. Deflection device and a diffraction devices may comprise components such as mirrors, prisms, gratings, holograms, wedge prisms, wedge lenses etc.

In another embodiment of the present invention, the means for moving the beam of the LSD may comprise an X-Y positioning stage or an X-Y-Z positioning stage or an n-axis robotic arm (e.g. a hexapod) in order to control and direct the beam of the LSD to a precise location.

In a preferred embodiment, the means for moving the beam comprises a stepper motor driven galvanometer, said stepper motor being equipped with a gearbox and mirror. In order to control both an X and a Y-axis two stepper motors (with gearbox and mirror) will be implemented.

The means for moving the beam may further or alternatively comprise piezoelectric elements, thus using the piezoelectric effect to induce a motion in the deflection device and/or the diffraction device. Alternatively, magnetostriction may be used to induce said motion on said deflection device or diffraction device. Alternatively the means for moving the beam mentioned above (stepper motor or piezoelectric- or magnetostrictive elements) may be implemented so as to induce movement of the cartridge relative to the device, whereas the beam does not move.

In an embodiment of the invention, the LSD is not a Compact Disc drive, i.e. the cartridge does not rotate relative to the device during movement of the beam.

Furthermore, one or more focusing means may be provided for focusing the light beam at one or more selected locations.

The focusing means may for example comprise a lens, a lens system (e.g. an acromat lens), a concave mirror, a Fresnel lens etc. In a preferred embodiment of the present invention, the focusing means comprises a concave mirror thus acting both as the beam directing element and a focusing means.

The LSD may comprise a laser.

The laser may be selected from the group consisting of semiconductor laser (e.g. a diode laser) a pumped solid-state laser, a gas laser etc. In a preferred embodiment, the laser is a diode laser.

The selected location on which the beam is focused may be a surface part of the cartridge material, a location inside the cartridge material or a location on the opposing side of the cartridge material. The focusing means may be controlled by a second programmable device, said focusing means is preferably be adapted to control the focal point of the beam in two or three planes

The programmable device may further comprise the focusing control means.

The beam of electromagnetic radiation from the LSD may comprise a wavelength of a wavelength range selected from ultra violet, visible or infrared. The beam may comprise electromagnetic radiation with a wavelength in the range 10 nm to 400 nm. The beam may comprise electromagnetic radiation with a wavelength in the range 400 nm to 750 nm. The beam may comprise electromagnetic radiation with a wavelength in the range 750 nm to 3000 nm. The beam may comprise electromagnetic radiation with a wavelength in the range 3000 nm to 14000 nm. The selection of wavelength may have an effect on the optical propagation of the beam in the BDS. For instance the selection of BDS materials may exclude a number of wavelengths due the fact that a given material is impermeable to a given wavelength.

The beam of the LSD may comprise a one or more of discrete wavelengths. These wavelengths may facilitate different functions related to the cartridge. The LSD may comprise one or more discrete wavelength emitters. The discrete wavelength emitters may be positioned inside the LSD at a relative position to another discrete wavelength emitter, thus the connected programmable device may regard the different wavelength emitters as part of two disconnected systems, however they may use the same means for moving the beam, the same BDS at the cartridge, respectively be able to trigger the same OD. The use of two or more discrete wavelength may be used when exciting different fluorescence probes. The LSD may comprise an infra red wavelength emitter used for driving fluids and facilitating reactions by inducing heat at discrete locations, and it may comprise a green, red, ultra-violet (or any other wavelength below the infra-red) wavelength emitter used to induce fluorescence activity at discrete locations. The LSD may comprise a multiple wavelength emitter, capable of emitting several discrete wavelengths (such as the single housing laser-diode announced by Sony august 2004, capable of selectively emitting 405 nm, 660 nm and 785 nm)

The optical detector (OD) may be selected from a range of transducers. Typically, these will be able to translate a level of optical radiation into an electrical signal. However, it is also envisioned that an opto-opto transducer may provide an optical output signal from an optical input signal. The OD may comprise a semiconductor device such as a photodiode, a phototransistor, a CCD. Also, the OD may comprise a device such as a photo multiplier tube (PMT). The OD may comprise a bandwidth filter. Typically, a bandwidth filter is selected so that only a selected wavelength will lead to a signal or the bandwidth filter may be constructed as an indiscriminate device, thus accepting a broad range of wavelengths.

The OD is typically positioned in the vicinity of the cartridge site holding the cartridge. The OD is normally positioned such that the optical signal—or part of, stemming from the LSD, diverted from a given BDS, will enter the OD and thus provide a signal to a connected control system that e.g. may be a programmable device. The optical design of the LSD may determine the accuracy with which the OD is positioned inside in relation to the cartridge site. The LSD may e.g. direct a collimated beam of a constant diameter, leading to a higher degree of required positional accuracy, see FIG. 1. Alternatively, a focussed beam may be used, such that the beam waist of said beam would be at or infinitesimally near, the surface of a BDS, thus resulting in a larger area of the beam being prone to enter the OD—illustrated by FIG. 4.

The programmable device may record and/or discriminate between

(a) the beam from the LSD entering the position of a BDS and thereby triggering the OD, and

(b) said beam leaving the position of the BDS thereby ceasing to influence the OD. An accuracy exceeding the size of a BDS may thus be achieved by means of simple computer calculations.

A number of ODs may be involved in the detection of the beam of the LSD, such as at least 1, 2, 3, 4, 5, 6, 7, 8, 9, 10 or 10, 20, 30, 40, 50 or 100, 200, 300, 400, 500 or 1000 ODs. One single OD may comprise a number of OD by itself—e.g. a CCD device comprising a large number of individual pixels. For example, 1 OD, 2 ODs, 3 ODs, 4 ODs, 5 ODs, 6 ODs, 7 ODs, 8 ODs, 9 ODs, 10 ODs or 10 ODs, 20 ODs, 30 ODs, 40 ODs, 50 ODs, 100 ODs, 200 ODs, 300 ODs, 400 ODs, 500 ODs or 1000 ODs may be involved in the detection.

A given OD may detect the signal directed from a single BDS or it may detect the signal from at least 2, 3, 4, 5, 6, 7, 8, 9, 10 or 10, 20, 30, 40, 50 or 100, 200, 300, 400, 500 or 1000, 10.000, 100.000 or 1.000.000 BDSs. An OD may e.g. detect the signal from at least 2, 3, 4, 5, 6, 7, 8, 9, 10 or 10, 20, 30, 40, 50 or 100, 200, 300, 400, 500 or 1000, 10.000, 100.000 or 1.000.000 BDSs.

The OD may detect a threshold level (e.g. the signal exceeding, respectively going below a certain level of radiation) and thus deliver a two-state signal to the controlling and computing system. The OD may also deliver an absolute or a relative numerical value, representing the level of the incoming optical signal from a BDS influenced beam. Interfacing equipment as well as the positional increments of the LSD, will determine the resolution, with which a numerical value is measured and recorded. Said numerical value may represent the level of optical signal entering the OD immediately after the beam has entered the influential region of a BDS, halfway through or just before leaving the influential region of a BDS.

Upon being influenced by the cartridge and/or BDS material, a given electromagnetic beam from the LSD may change due to specific properties of the cartridge material or matters herein. Certain types of polymer may exhibit so-called autofluorescence that may eventually add to the signal entering the OD. Certain substances, residing inside the cartridge, may also have a fluorescing component—also adding to the optical signal entering the OD, respectively influencing the signal from the OD to the programmable device. In general the level of these types of signals, will be of orders of magnitude lower than that stemming directly from the LSD. The task of discriminating between these signals and the signal from the LSD and thus eliminating said signal component (if necessary), is one that can be resolved by technical solutions obvious to those skilled in the art. The signal stemming from the LSD without having an altered wavelength property will comprise the majority of a signal entering the OD, whereas the signal stemming from either an altered part of the original LSD beam or stemming from a different source of radiation, will comprise a minority of the signal entering the OD.

A cartridge site is provided to receive a cartridge. The cartridge site may be operated in a manual fashion such that a cartridge is placed by hand respectively fastened by hand or the cartridge may be fed to and placed at the cartridge site by means of mechanical installations. A combination of the two may be comprised (e.g. the cartridge is placed at the cartridge site by hand where after automatic mechanical installations lock or fasten the cartridge at the cartridge site.)

The cartridge site may be constructed such that a provided cartridge is placed and fastened with a predetermined degree of accuracy. The degree of accuracy may be significantly lower than that provided by the LSD in connection with the BDS; however the design of the cartridge site and the degree of accuracy with which a cartridge is placed and fastened in said cartridge site is an engineering challenge which can be considered and resolved by a person skilled in the art.

The cartridge site may for example comprise a recessed cutout thus accepting the cartridge outline such that the cartridge will fit into the recessed cutout. Said cutout may comprise yet another cutout of a smaller area, thus providing access to a part of the cartridge. The cartridge site may comprise an upper part that is either spring loaded or operated by e.g. a motor or a magnet, so as to provide the fixation of the cartridge after being inserted in the recessed cut-out. In another embodiment a number of posts will be positioned at the outline of a cartridge such that said cartridge is held in a firm and well-defined position after being positioned at the cartridge site. The cartridge site may be injection moulded in a thermo plastic or it may be machined in a suitable material (e.g. polymer, steel etc.)

The cartridge comprises one or more BDS. The cartridge may additionally comprise a number of structures, sites or functions to be addressed in a precise manner.

A cartridge may be a plate, thus having a larger surface area (e.g. from 1 to 100 cm²) and a relatively smaller thickness (e.g. from 500 μm to 10 mm). It may be squared of approximately equal dimensions (e.g. 4×6 cm²) or it may be in any polygonal or circular shape (e.g. a CD ROM disc). In a preferred embodiment the cartridge is square having an areal dimension of 10-20 cm² and a thickness of 2-5 mm.

It is also envisioned that the term cartridge can be interpreted broadly, i.e. not limited to the above-mentioned embodiments. The term cartridge may e.g. encompass sheets or films, single layers of sheets, films or plates. The cartridge may comprise two or more layers of sheets, films, or plates.

A cartridge could also comprise more complex structures such as ostomy appliances, medical implants, cellular phones, disposable lab-on-a-chip systems, and so forth.

A structure may be a microfluidic channel structure in which analytes and reagents may be present—either prior to or sometime after insertion of said cartridge. A site on said cartridge may comprise a confined area that in the process of being addressed will either facilitate a reaction or identify an emitted signal or in fact do both simultaneously (e.g. facilitate a reaction at a given site and during the course of the reaction, respectively identify the outcome of said reaction). A site may comprise a functionalised surface area or it may comprise a reservoir that may in turn comprise a functionalised surface part (e.g. biochemical markers may be immobilised on said functionalised surface part, or a surface part may have a catalytic property stemming from physical surface structure). A function may be an optomechanical function that is either facilitated by, initiated by or halted by—said function being addressed by external means. Said function could be a thermo-pneumatic pumping scheme, a thermo-pneumatic valve or a thermal chamber. A function may also comprise a means of altering physical properties of a given addressed area (e.g. transforming hydrophobic areas into hydrophilic areas or altering optical properties such as reflective or diffractive properties).

A structure may comprise a site comprising a function (e.g. a microfluidic channel with functionalised surface areas, acting as a thermal chamber).

Useful micro-channels, thermal chambers and valves are found in WO 2004/016 948, which is incorporated herein by reference. In a preferred embodiment of the invention, the system of the present invention is a micro pumping system, a micro valve system, a micro mixing system, a thermal reactor system, or a micro system as disclosed in WO 2004/016 948, which is incorporated herein by reference.

The beam diverting structure (BDS) will typically have an optical beam path altering properties. A BDS may e.g. comprise a prism, a lens, a grating, a reflecting surface or a combination of these (e.g. a prism with one or more surfaces being coated with a reflective substance). A BDS may e.g. comprise a portions functioning like a prism, a lens, a grating, a reflecting surface or a combination of these. A BDS may e.g. be recessed into the cartridge material, be protruding from or be part of the intermittent surface. In a special embodiment the BDS may comprise a blocking part or a scattering part of a translucent cartridge such that a beam is blocked or scattered when shone on a specific location. Also the BDS may comprise a transparent window. The transparent window is typically used in a light blocking or light scattering area of the cartridge and may be used for letting the beam pass through the cartridge and e.g. be detected by the OD.

In a preferred embodiment the BDS comprises a prism construction. The angle of a prism surface can be any angle with respect to the cartridge surface; a preferred angle of a prism could be in the range from 0.1 to 45 degrees 45 to 99.9 degrees—depending on the refractive index of a chosen beam carrier (substrate) material. The combination of the refractive index of the chosen substrate material and selected prism angle, together with the selected wavelength of the LSD, will result in a beam being either diverted when passing though the cartridge material or in a partial internal reflection such that the beam will travel inside the substrate, after being influenced by the beam diverting structure—such that the cartridge will act as an optical wave guide on a diverted beam, or the prism angle will be chosen such that total internal reflection occurs and the resulting deflected beam will exit on the same side of the cartridge as it entered.

In a preferred embodiment of the invention at least one BDS is not a micro-channel.

Though functional BDS may have many different dimensions, they are typically rather small. For example a BDS may have at least one dimension of at most 1000 μm, more preferably at least one dimension of at most 500 μm, such as at most 250 μm or at most 150 μm, and even more preferably at least one dimension of at most 100 μm, such as at most 50 μm or at most 5 μm.

The BDS material may have an optical property such that it will accept and guide and divert incoming light. In a preferred embodiment the BDS is constructed in a translucent polymer; said polymer being used for the forming of the cartridge material.

A BDS will normally have a well-defined positional relationship with one or more other structures of the cartridge comprising the BDS. In a preferred embodiment the BDS are manufactured utilizing the same production cycle and thus—method, as other structures on a cartridge (e.g. a polymer cartridge is injection moulded in a single moulding process using a mould having the imprint of both BDS and microfluidic structures). Eventually whether moulding/embossing, micro machining, etching is applied as a method of production, the accuracy of the process will determine the spatial relationship between the BDS and other structures on/in the cartridge)

Thus, in a preferred embodiment of the invention the cartridge comprised a surface, which surface forms the at least one BDS and one or more micro-channels.

The cartridge comprise at least 2 BDSs such as at least 3, 4, 5, 6, 7, 8, 9, 10, 11, 12, 13, 14, 15, 16, 17, 18, 19, 20, 25, 30, 40, 50, 75, 100, 150, 200, 250, 300, 400, 500, 600, 750, 1000, 2000, 3000, 4000, 5000, 7500, 10000, 100000, or 1000000, such as at least 10000000 BDSs.

The cartridge comprise in the range of 1-10000000 BDSs such as e.g. 1-5, 5-10, 10-20, 20-50, 50-100, 100-250, 250-500, 500-1000, 1000-5000, 5000-10000, 10000-100000, 1000000-1000000, or 1000000-10000000 BDSs.

The cartridge may be constructed in any fashion and may well be comprised of a number of materials. The whole or part of the cartridge may be constructed in a polymer, glass, silicon, quartz, ceramic or any other material that exhibits properties that will suit requirements of the functions of said cartridge. Structures on/in the cartridge may include BDS as well as structures to suit other functions or requirements. A cartridge may be injection moulded, hot embossed, micro machined, etched or may in fact involve a number of different fabrication steps and methods (e.g. an injection moulded polycarbonate structure, containing BDS and microfluidic channels is infra red welded to a micro machined glass carrier acting as a lid, etc.).

The terms “micro-channel” and “microfluidic channel” are used interchangeably. A micro-channel typically has a smallest cross-sectional dimension in the range of 1-1000 μm, such as 10-500 μm, and preferably in the range of 25-250 μm. The smallest cross-sectional dimension may e.g. be measured as the smallest distance between two opposing micro-channel walls or as the smallest effective cross-sectional diameter of the channel. The effective cross-sectional diameter is measured as the inner circumference of the cross section of the channel divided by π, i.e. 3.14.

A cartridge may additionally encompass reservoirs comprising liquid phase chemical or biological reagents, buffers or solvents. A cartridge may also comprise non-liquid reagents (e.g. freeze dried enzyme vials, immobilised nucleic acid probes, functionalised beads, ceramic or metallic or crystalline powders etc.). A cartridge may also comprise a number of reservoirs for waste storage.

The reagent may comprise one or more chemical reagents selected from the group consisting of a salt, a pH-buffer, a detergent, a viscosity modifying agent, an antiseptic agent, a dye and a fluorescent probe.

Also, the reagent may comprise one or more the biological reagent selected from the group consisting of an antibody; an enzyme such as e.g. a polymerase or a restriction enzyme; a protein; a cell; a cell component such as e.g. a cell receptor; a DNA molecule; or a RNA molecule.

Another aspect of the present invention relates to a method of detecting the position a BDS relative to a LSD, the method comprising the steps
(a) providing a system as described herein,
(b) associating a cartridge with the cartridge site,
(c) directing the beam of the LSD to the cartridge and moving the beam of the LSD relative to the cartridge,
(d) measuring the signal from the OD corresponding to the relative position of the beam on the cartridge.
(e) determining that a BDS is positioned at a relative position if the signal of the OD is significantly modified at that relative position.
(f) Ultimately determining the relative position of the cartridge based on the relative position of the BDS, where after the LSD can perform additional operations affecting the cartridge and/or components herein.

The additional operation of the LSD may comprise the creation of a bubble in a liquid filled microstructure, such as e.g. a micro-channel, a micro valve or a reservoir, by means of the electromagnetic energy of the beam of the LSD. Creation of bubbles in liquid filled microstructures, such as micro-channels, a micro valves or reservoirs, can be accomplished as described in the PCT application WO 2004/016 948, which is incorporated herein by reference.

In the present context “associated with the cartridge site” means that the cartridge is located at the cartridge site. The cartridge may e.g. be located manually or by automated means or by a combination of the two.

The optical scanning beam is influenced by optical means in combination with controlled mechanical means, thus providing a precisely controlled deflection, reflection or divergence of the beam.

The signal of the OD is significantly modified when the cartridge is associated with the cartridge site and the beam of the LSD is directed to the BDS.

The signal from the OD may have an amplitudal relationship with the position of the beam relative to the BDS. A given beam may be only partially deflected (due to width of the beam) when entering the influential region of a BDS. E.g. when 500% of the beam is influenced by the BDS, 500% of the beam will be deflected towards and thus entering the OD, where the remaining 500% will continue unaffected by the BDS and thus not add to the signal from the OD, which thus will represent a unique position of the beam being half way past or into the BDS. Similarly for e.g. 25%, 750%, 10%, 90%, 50%, 95% etc. The resolution with which a given beam will be detected will depend on the opto-mechanical components, the quality of the BDS and the signal to noise ratio of the OD and connected equipment. It is well understood that it is an engineering task, which can be overcome by available electromechanical components.

The OD may alternatively provide a discrete signal when the signal entering the OD from the BDS pass a certain threshold value—either below or above a given fixed threshold value.

When a given BDS is accessed by the LSD and significantly modified signal from the OD (either discrete or analogue) is detected, the position of the BSD is recorded, such that when accessing another BDS the precise positional relationship is recorded between the two, —hence forward a third BDS, a fourth etc. As the before mentioned, sites, structures etc. on the cartridge normally have a precise relative positional relationship with the BDS's. Consequently, with using the knowledge of the position of the BDS's, these sites and structures may be accessed by the LSD. The precise location of the LSD—relative to the cartridge and/or the BDS and/or the sites and structures is normally of no importance when the relative position of the BDS's is known in relation to the sites and structures.

An additional aspect of the present invention relates to a method of reading a label on a cartridge, the method comprising the steps
(a) providing a system as described herein, wherein the cartridge comprises the at least one label, said label comprising at least two BDSs,
(b) associating a cartridge with the cartridge site,
(c) directing the beam of the LSD to the cartridge and moving the beam of the LSD relative to the cartridge,
(d) measuring the signal from the OD corresponding to the relative position of the beam on the cartridge.
(e) locating the at least two BDSs by determining that a BDS is positioned at a relative position if the signal of the OD is significantly modified at that relative position, and
(f) interpreting the label or set of data using the presence or lack of presence of any of the at least two BDSs at predefined relative positions and/or the significantly modified signal of the OD at each of the BDSs
   thus providing a method of identifying the presence—or lack of, a beam diverting structure at a given predefined position, indicating a digital ‘1’ or ‘0’—respectively; and ultimately providing a means for storing digital information on a cartridge—respectively reading said information, when a number of individual sites are coded and read and interpreted in this fashion.

Yet another aspect of the present invention relates to a method of producing a product comprising a cartridge, said method comprising the steps of:
1) providing a cartridge comprising at least one BDS,
2) detecting the position of the BDS relative to a LSD according to the method described herein,
3) performing an additional production step involving the cartridge.

The additional production step is typically selected from the group consisting of milling, drilling, abrasing, biochemical spotting, filling positioning, painting, writing, laser ablating, and laser welding.

In a preferred embodiment of the invention, the additional production step is performed using the LSD. This is advantageous since the detection of the position of the BDS relative to the LSD makes it possible to perform the additional production step using the LSD with a high precision. This is particularly advantageous when the product involves the microstructures, which typically should be assembled with a very high precision.

When the additional production step is performed using the LSD, the additional production step is preferably selected from the group consisting of laser drilling, laser writing, laser ablating, and laser welding.

The method of producing a product may furthermore comprise a step of reading a label on the cartridge according to the method as described herein.

Production of the product comprising the cartridge often relies on precise knowledge of position of one or more components or locations on these are required in order to access this or these position(s). Production of the product comprising the cartridge may require precise mechanical machining (e.g. milling, drilling or abrasion) at a precise location related to moulded parts and thus related to one or more BDS. Production of the product comprising the cartridge may require local functionalisation (e.g. the spotting or filling with a biochemical component) at precise locations such as hybridisation sites or reaction wells, which are again positioned relative to enclosed BDS. Production of the product comprising the cartridge may require laser machining such as laser ablation at a precise location or locations, or the production of the product comprising the cartridge may require laser welding at precise locations or at a precisely defined perimeter or perimeters. Laser welding seam may advantageously be applied precisely around the edges of a microfluidic circuit so that the microfluidic channels are not affected, and/or so that heat sensitive biochemical components are not denatured.

In the described instances related to production of the product comprising the cartridge, one or more incorporated BDS would provide the precise locations of components to be accessed by the above-mentioned functions, in accordance with the methods and using the devices described in the previous paragraphs.

The cartridge may comprise one or more BDSs for the purpose of being used only in connection with production as described here-over or they may additionally serve the purpose of providing positional information in connection with subsequent use of the product.

### BRIEF DESCRIPTION OF THE DRAWINGS

FIG. 1 shows the involved components in connection, where a collimated beam from the LSD is diverted by a BDS.

FIG. 2 illustrates a close-up of a subset of the enclosed BDS.

FIG. 3a-b is a side view of a beam travelling through a cartridge (a)—respectively—being diverted towards an OD by a BDS (b)

FIG. 4 shows an embodiment of the invention, where a focussed beam is focussed at and directed towards a BDS.

FIG. 5a-e illustrates a number of different embodiments of a BDS.

FIG. 6a-b shows a cartridge where a number of BDS forms a label or set of data.

FIG. 7a-c shows an optical photo of a BDS being approached and influenced by a beam from a LSD.

### DETAILED DESCRIPTION OF THE DRAWINGS

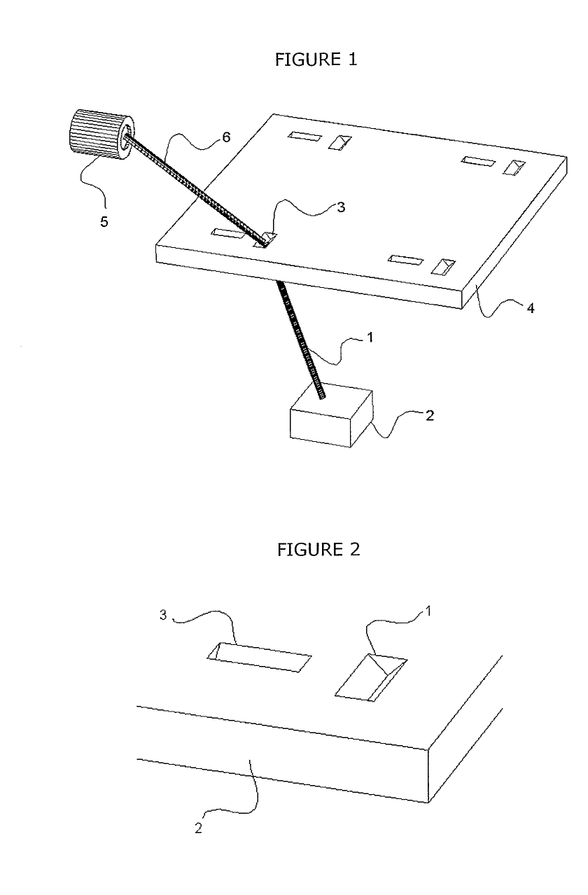

FIG. 1 shows the involved components in connection, where a collimated beam from the LSD is diverted by a BDS. A beam 1 is directed from the LSD 2 towards a BDS 3 that is part of the cartridge 4. The BDS 3 imposes a directional change in the beam (now 6) towards the OD 5 that will transmit a signal, indicating that the beam is influenced by the BDS 3. Electrical connections, leading the signal from the OD to interfacing equipment is not shown here.

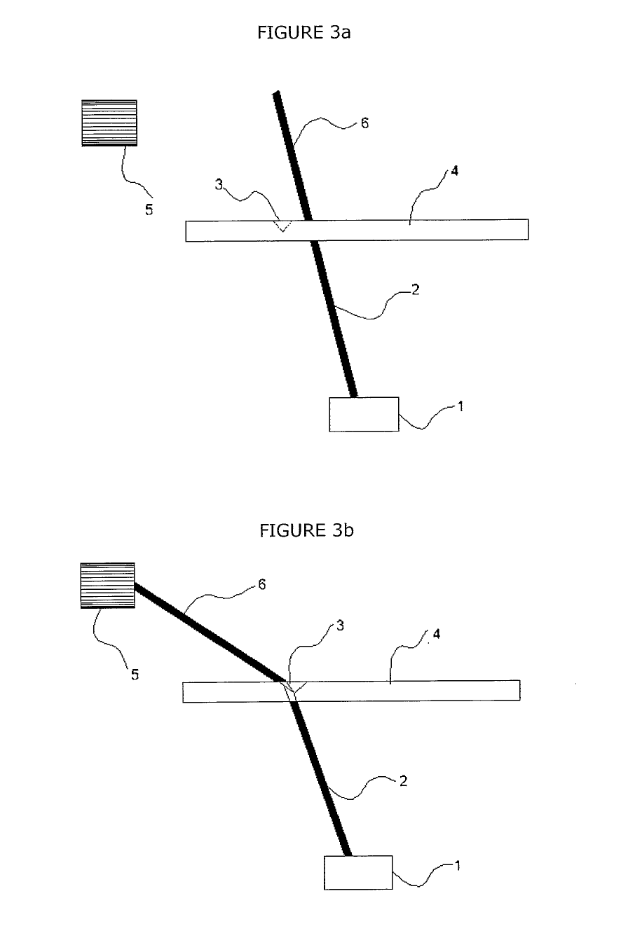

FIG. 2 illustrates a close-up of a subset of the enclosed BDS. The cartridge substrate 2 is holding a BDS 1 and another BDS 3. Both BDS consist of a double sloping recessed prism structure. The BDS 1 is angled 90 degrees in the plane relative to the BDS 3, each prism will thus provide a maximum resolution on 90 degree angled axis. A beam scan imposed by the LSD, may in this configuration consist of a first scan along an axis in the plane perpendicular with a first slope of BDS 1, thus establishing a position of said first slope at this one axis. Following that first scan, a second scan will travel the perpendicular axis until a first slope of BDS 3 is reached and registered.

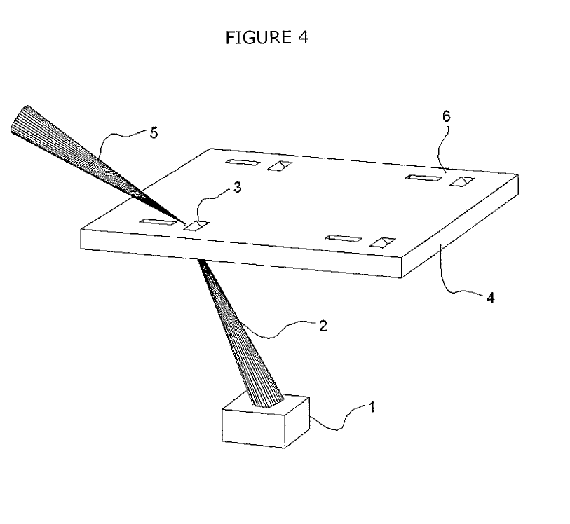

FIG. 3a-b is a side view of a beam travelling through a cartridge (a)—respectively—being diverted towards an OD by a BDS (b) In 3a a collimated beam 2 is directed from the LSD 1. It passes unaffected through the translucent cartridge 4, hereafter being defined as a beam part 6. The beam is not affected by the BDS 3, hence no signal enter the OD 5. In 5b the beam 2 directed from the LSD 1 enters the cartridge 4 at a position where a BDS 3 will affect and divert the beam (now 6) in a direction where the OD 5 will register this. The signal entering the OD will provide a signal to the programmable device (a computer—not shown).

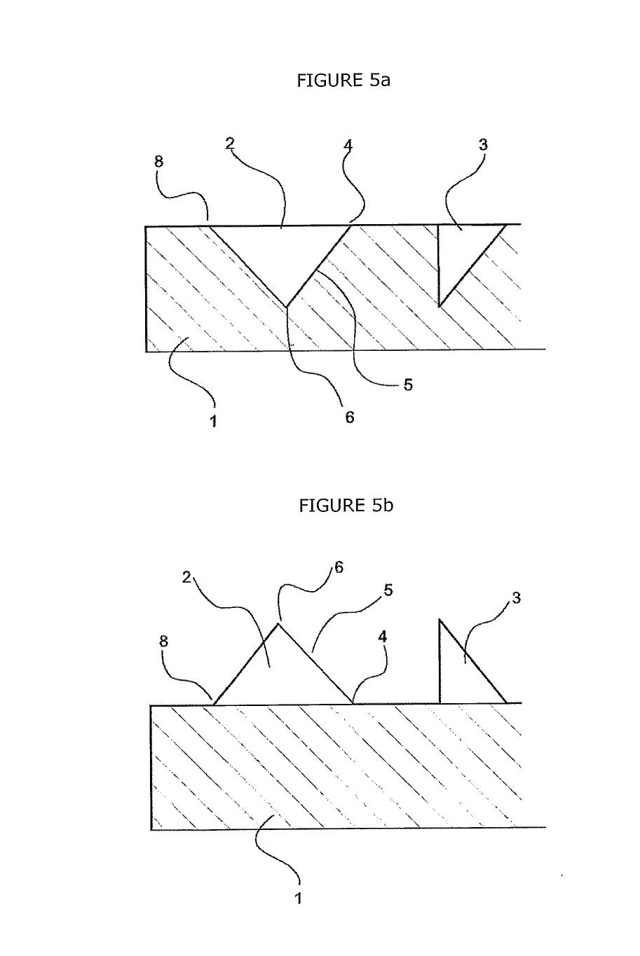

FIG. 4 shows an embodiment of the invention, where a focussed beam is focussed at and directed towards a BDS. The beam 2 being directed from the LSD 1, focussed at a point where the BDS 3 will affect and divert the beam towards the OD 5. The use of a focussed beam, will increase the resolution with which the travel of the beam can be registered, as the focussed beam will only affect a very small area on the cartridge (being positioned at the beam-waist) The diverted beam-part 5 will cover a larger area as the beam diameter is expanding as it leaves the cartridge 4 surface and the BDS 3, thus lowering the accuracy with which a given OD (not shown) is positioned relative to the cartridge 4 and the cartridge site (not shown)

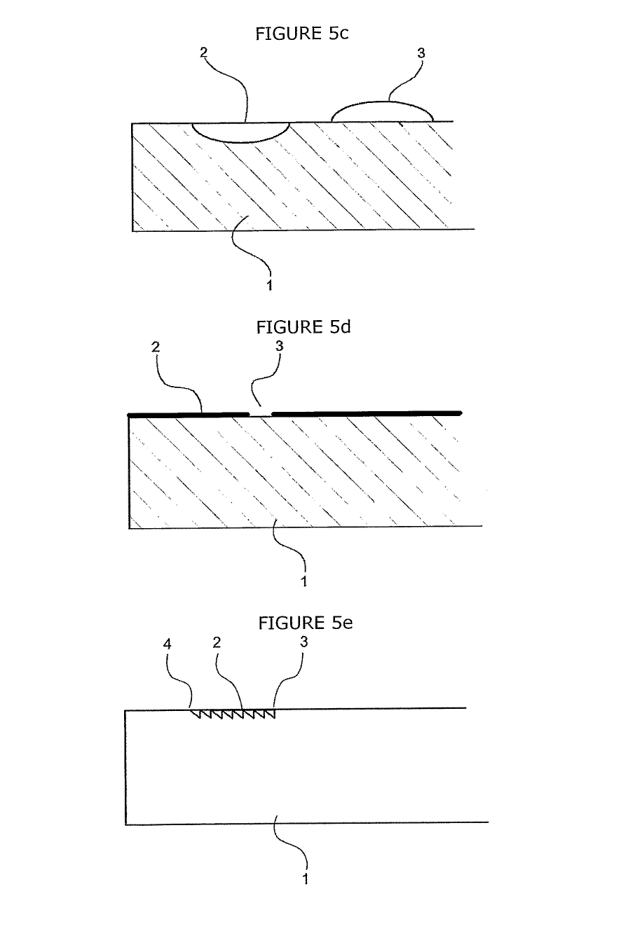

FIG. 5a-e illustrates a number of different embodiments of a BDS. In 5a a double sloping recessed prism BDS 2 is shown next to a single sloping prism BDS 3, thus representing two individual embodiments of a BDS. The recessed prism BDS is characterised by: a translucent substrate material 1 with an index of refraction differing from ‘1’ (vacuum/air) thus forming the body of the BDS 2. A first edge 4 defines together with an edge 6 an angled slope 5. A beam passing the edge 4 from the right to the left will exit from the surface of the slope 5. The opposing slope (edge 6 to edge 8) will form a slope diverting a beam in the opposing direction. The single sloping BDS 3, will fulfil the purpose of providing an edge and an angled slope, however the implementation of a double sloping BDS will add three individual edges (4, 6 and 8) which will increase the precision and the double sloping BDS 2, will ease production (e.g. providing low slip-angles in an injection moulding or hot embossing process).

FIG. 5b also illustrates a double—respectively single—sloping prism BDS, however—as opposed to 5a the embodiment encompass protruding BDS (6 and 3) The function of the edges (8, 6 and 4) and the slopes (5 and opposing) are identical to the functions mentioned above concerning 5a.

FIG. 5c illustrates the use of a recessed BDS 2—respectively—protruding BDS 3, characterised by having a curvature. The two (2 and 3) are independent of one another. Said curvature may be semi circular, elliptic, parabolic or any other shape which will induce either a change in direction of a beam passing through or a focussing/defocusing of said beam. The change in beam composition may identified as an increase in signal strength at the point of focus or as a weakening/extinction of the signal, if being defocused/dispersed by the curvature BDS.

FIG. 5d shows a special embodiment of a BDS, acting as a blocking layer with a translucent part at a defined location. Said blocking layer may act as a band pass filter thus shielding only a portion of the wavelength spectrum. The special embodiment may also comprise the BDS part to act as a blocker of the LSD wavelength thus being translucent at any location where a BDS is not present.

FIG. 5e shows a BDS comprising an index grating 2. The index grating 2 will divert a passing through beam when it passes through the cartridge material 1 in a region between 3 and 4

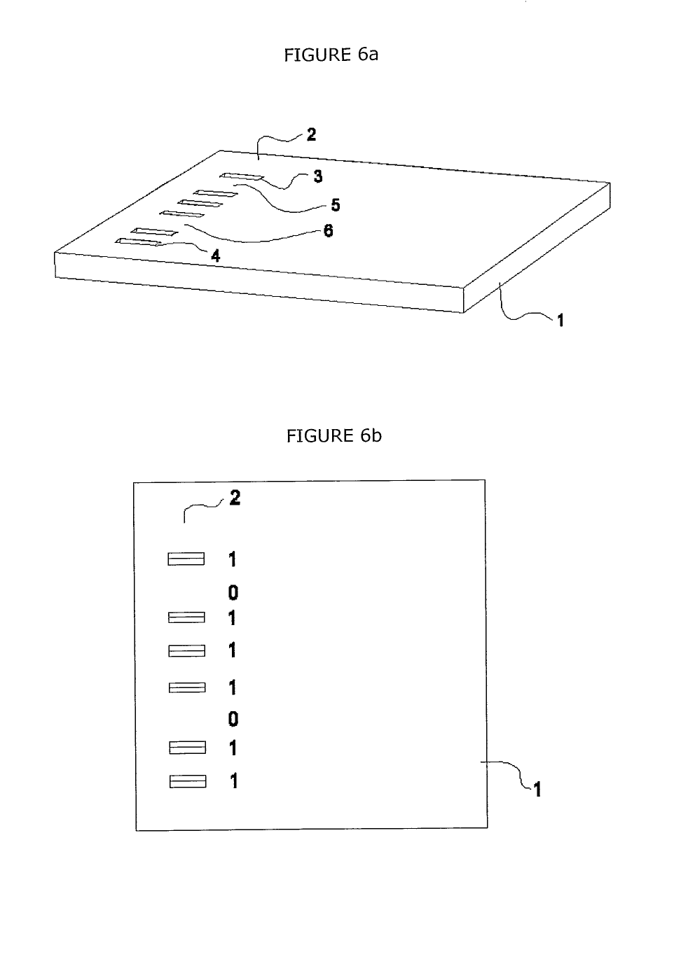

FIG. 6a-b shows a cartridge where a number of BDS forms a label or set of data. FIG. 6a illustrates the cartridge 1 with a label or set of data 2 comprising a number of recessed BDS positions (from 3 to 4) At positions marked 5 and 6 a BDS is left out in an otherwise evenly spaced collection of BDS. The missing BDS at positions 5 and 6, represent a digital state as opposed to a position where a BDS is present, thus representing the opposite digital state. Though beam scan of the LSD (not shown) from position 3 to position 4, a connected OD (not shown) will enable the registration of a collection of digital states, ultimately translated into a unique set of date.

In FIG. 6b, the presence—respectively absence of a BDS at a given position is marked as a digital ‘1’—respectively a digital ‘0’. The eight potential BDS positions make up a digital eight bit digital number. In FIG. 6b the presence/absence of BDS's is read as ‘10111011’ which using the digital system translates into the decimal number ‘187’

A Label or set of data may comprise a very large number of predefined BDS positions; these are not shown in FIG. 6a-b.

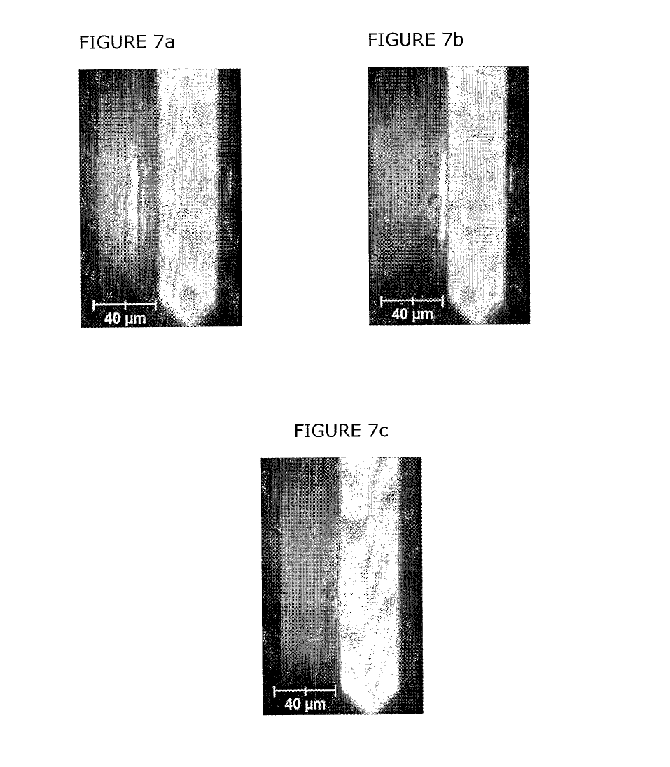

FIG. 7a-c shows an optical photo of a BDS (a double sloping prism) being approached an influenced by a beam from a LSD. In FIG. 7a the laserbeam is about 20 μm from entering the influential region of the BDS. In FIG. 7b the laserbeam is only a few micrometers (2-3 μm) from entering the BDS region. In FIG. 7c the laserbeam has passed the first edge of the BDS; this can be identified by the fact that the intensity of the laserbeam has lowered considerably due to the diverting of the beam.

### EXPERIMENTS

An experimental set-up was prepared as follows:

A 2 mm polycarbonate substrate (20*20 mm) was micromachined using an Excimer laser. A BDS—a double sloping prism structure as described in the text, was machined using a rhombic laser beam aperture, thus resulting in a 45 degree sloping structure of length 200 μm, width 40 μm and depth 20 μm (as depicted in FIG. 7a-c—top view)

A consumer grade low-cost photo-diode (SFH203) was positioned with no specific accuracy such that it was facing the left edge of the substrate material. No optical elements were utilised to enhance the detection of the optical signal. The photo-diode was coupled (directly) to a voltmeter such that it would act as a voltage generator (voltage mode).

A focussed laser-beam (stemming from a high-power commercially available laserdiode (LD)—500 mW, 808 nm) was directed towards the substrate from the opposing side of the camera-microscope installation. The laser-beam was directed using a computer-controlled tilting mirror—LSD. The tilting mirror resolution enabled the movement of the beam in steps of 5 μm. The laser-power was down regulated (from the full 500 mW provided by the LD) by operating the LD in a pulsemode. A pulse of 3 μs was fired every 500 μs thus providing a net power of 0.6% of the full effect.

The “dark-voltage” of the photo-diode was 2 mV. After switching on the laser (positioned far from the BDS—FIG. 7a) the voltage was fluctuating about 25-27 mV, stemming from laser light being dispersed throughout the substrate material. When approaching the edge of the BDS the measured voltage would rise to 69 mV (FIG. 7b)—due to the Gaussian beam profile of the laser. After passing the edge of the BDS (FIG. 7c) the voltage would rise to 108 mV thus representing an increase in signal of 57% from the signal detected immediately before entering the influential region of the BDS. During the following steps (of 5 μm) the detected level would fluctuate between 101 mV and 113 mV due to changes in surface roughness of the micromachined BDS slope. The signal rose to 130 mV when approaching the bottom of the BDS—also due to increased dispersion (that is the lower edge, before rising towards the opposing surface edge) where after it dropped of considerably (65-55 mV) when travelling towards the opposing edge.

To conclude it is possible to precisely detect the position of a travelling laser-beam relative to a recessed BDS, with a precision defined by the resolution of the LSD (steps of 5 μm). The OD (optical detector) was of low cost (0.5$)—no further optical elements was involved to enhance signal detection, and the OD was positioned with little regard to accuracy.

1. A system comprising
(a) a cartridge comprising at least one beam diverting structure (BDS); and
(b) a device comprising:
(i) a cartridge site capable of receiving the cartridge;
(ii) a laser scanning device (LSD) capable of emitting a beam of electromagnetic radiation, said LSD configured to move the beam relative to a cartridge associated with the cartridge site; and
(iii) an optical detector (OD), wherein
the LSD and the OD are configured such that when the cartridge is associated with the cartridge site and the beam of the LSD is moved to the at least one BDS, the signal from the OD is increased or decreased).

2-46. (canceled)

47. The system according to claim 1, wherein the device further comprises a programmable device.

48. The system according to claim 1, wherein the LSD comprises a laser.

49. The system according to claim 1, wherein the LSD further comprises a means for moving the beam.

50. The system according to claim 1, wherein the beam of electromagnetic radiation has a wavelength in a range selected from the group consisting of ultra violet, visible and infrared.

51. The system according to claim 1, wherein the signal of the OD is increased or decreased if said signal is increased when the cartridge is associated with the cartridge site and the beam of the LSD is directed to the BDS.

52. The system according to claim 1, wherein the signal of the OD is increased or decreased if said signal is decreased when the cartridge is associated with the cartridge site and the beam of the LSD is directed to the BDS.

53. The system according to claim 1, wherein the signal of the OD is increased or decreased if said signal is increased to reach or exceed a threshold when the cartridge is associated with the cartridge site and the beam of the LSD is directed to the BDS.

54. The system according to claim 1, wherein the signal of the OD is increased or decreased if said signal is decreased to reach or goes below a threshold when the cartridge is associated with the cartridge site and the beam of the LSD is directed to the BDS.

55. The system according to claim 1, wherein the signal of the OD is increased or decreased if the signal profile, which is the measured signal as a function of the measurement position on the cartridge, comprises a BDS characteristic feature.

56. The system according to claim 1, wherein at least 50% of the electromagnetic radiation that the OD receives originates from LSD, when the cartridge is associated with the cartridge site and the beam of the LSD is moved to the at least one BDS.

57. The system according to claim 1, wherein at most 20% of the electromagnetic radiation that the OD receives is from a source different from the LSD, when the cartridge is associated with the cartridge site and the beam of the LSD is moved to the at least one BDS.

58. The system according to claim 1, wherein the BDS comprises a portion that can reflect at least a part of the beam.

59. The system according to claim 1, wherein the BDS comprises a portion that can deflect at least a part of the beam.

60. The system according to claim 1, wherein the BDS comprises a portion that can diffract at least a part of the beam.

61. The system according to claim 1, wherein the BDS comprises a portion that can scatter at least a part of the beam.

62. The system according to claim 1, wherein the BDS comprises a structure selected from the group consisting of a lens, a prism, a grating, a mirror, and an optical filter.

63. The system according to claim 1, wherein the cartridge comprises at least 2 BDSs.

64. The system according to claim 1, wherein the cartridge comprises in the range of 1-10000000 BDSs.

65. The system according to claim 1, wherein the cartridge further comprises a micro-channel.

66. The system according to claim 1, wherein at least one BDS is not a micro-channel.

67. The system according to claim 1, wherein at least one BDS does not fluoresce when the beam is directed to the at least one BDS.

68. The system according to claim 1, wherein the cartridge comprises a body that defines at least a portion of the BDS.

69. The system according to claim 68, wherein said body further defines at least a portion of the micro-channel.

70. The system according to claim 68, wherein said body comprises a material selected from the group consisting of polymers, glass, silicon, and quartz.

71. The system according to claim 68, wherein the body is prepared by injection moulding.

72. The system according to claim 1, wherein the cartridge further comprises a chemical or biological reagent.

73. The system according to claim 72, wherein the chemical reagent is selected from the group consisting of a salt, a pH-buffer, a detergent, a viscosity modifying agent, an antiseptic agent, a dye, and a fluorescent probe.

74. The system according to claim 73, wherein the biological reagent is selected from the group consisting of an antibody, an enzyme, a protein, a cell, and a cell component.

75. A method of detecting the position a BDS relative to a LSD comprising:
(a) providing a system according to claim 1;
(b) associating the cartridge with the cartridge site;
(c) directing the beam of the LSD to the cartridge and moving the beam of the LSD relative to the cartridge;
(d) measuring the signal from the OD corresponding to the relative position of the beam on the cartridge; and
(e) determining that a BDS is positioned at a relative position if the signal of the OD is increased or decreased at that relative position.

76. The method according to claim 75, further comprising the step of determining the relative position of the cartridge based on the relative position of the BDS.

77. The method according to claim 75, further comprising the step of performing an additional operation affecting the cartridge with the LSD when the position of the cartridge relative to the LSD is determined.

78. The method according to claim 75, wherein the additional operation of the LSD comprises creating a bubble in a liquid filled micro structure.

79. The method according to claim 75, wherein the signal of the OD is increased or decreased if said signal is increased when the cartridge is associated with the cartridge site and the beam of the LSD is directed to the BDS.

80. The method according to claim 75, wherein the signal of the OD is increased or decreased if said signal is decreased when the cartridge is associated with the cartridge site and the beam of the LSD is directed to the BDS.

81. The method according to of claim 75, wherein the signal of the OD is increased or decreased if said signal is increased to reach or exceed a threshold when the cartridge is associated with the cartridge site and the beam of the LSD is directed to the BDS.

82. The method according to claim 75, wherein the signal of the OD is increased or decreased if said signal is decreased to reach or go below a threshold when the cartridge is associated with the cartridge site and the beam of the LSD is directed to the BDS.

83. The method according to claims 75, wherein the signal of the OD is increased or decreased if the signal profile comprises a BDS characteristic feature.

84. The method according to claim 83, wherein the BDS is located at a position where a BDS characteristic feature occurs.

85. The method according to claim 83, wherein the BDS is located adjacent to a position where a BDS characteristic feature occurs.

86. A method of reading a label on a cartridge comprising:
(a) providing a system according to claim 1, wherein the cartridge comprises the at least one label, said label comprising at least two BDSs;
(b) associating the cartridge with the cartridge site;
(c) directing the beam of the LSD to the cartridge and moving the beam of the LSD relative to the cartridge;
(d) measuring the signal from the OD corresponding to the relative position of the beam on the cartridge;
(e) locating the at least two BDSs by determining that a BDS is positioned at a relative position if the signal of the OD is increased or decreased at that relative position; and
(f) interpreting the label using the presence or lack of presence of any of the at least two BDSs at predefined relative positions or the increased or decreased signal of the OD at each of the BDSs.

87. A method of producing a product comprising a cartridge comprising:
a) providing a cartridge comprising at least one BDS;
b) detecting the position of the BDS relative to a LSD according to the method of claim 75; and
c) performing an additional production step involving the cartridge.

88. The method according to claim 87, wherein the additional production step is selected from the group consisting of milling, drilling, abrasing, biochemical spotting, filling, positioning, painting, writing, laser ablating, and laser welding.

89. The method according to claim 87, wherein the additional production step is performed using the LSD.

90. The method according to claim 88, wherein the additional production step is performed using the LSD.

91. The method according to claim 89, wherein the additional production step is selected from the group consisting of laser drilling, laser writing, laser ablating, and laser welding.

92. The method according to claim 90, wherein the additional production step is selected from the group consisting of laser drilling, laser writing, laser ablating, and laser welding.

93. The method according to claim 87, further comprising a step of reading a label on the cartridge using a method according to claim 86.
